(19) United States
(12) Patent Application Publication
(10) Pub. No.: US 2014/0080103 A1
(43) Pub. Date: Mar. 20, 2014

(54) Method for teaching a second language using an infant situational approach

(71) Applicant: Gerald Burrage, Quebec (CA)

(72) Inventor: Gerald Burrage, Quebec (CA)

(21) Appl. No.: 13/986,879

(22) Filed: Mar. 5, 2012

(51) Int. Cl. G09B 19/06

(52) U.S. Cl. CPC G09B 19/06
USPC 434/157

(57) ABSTRACT

Learning a language and speaking a language are two completely different processes which are in no way related. Learning a language is cognitive, linking it to cause and effect, reasoning, and intelligence. Speaking a language is not cognitive and therefore is in no way related to cause and effect, reasoning, and intelligence.

Physical barriers must be eliminated to prevent students from abandoning second language programs.

The learning expectations of students must be corrected in order to remove physical speech impediments and prevent them from re-appearing.

D-BLOK presents the environment of a very small child to facilitate the understanding of the student that the action of speaking is not cognitive.

It is a teaching method that creates an environment to facilitate oral communication for: People beginning to speak a second language, people lacking confidence in speaking a second language, people with oral communication problems in first or second language.

### FIELD OF THE INVENTION

The present invention relates to a teaching method used to facilitate oral production of a first or second language.

### DESCRIPTION OF PRIOR ARTS

Language learning is as old as language itself on the planet. Man has always communicated one way or another but verbal communication evolved in early man to become the easiest and simplest form. Men didn't actually concentrate on the method of learning a language until they began to use written communication. Grammar translation was the first method of becoming familiar with another language. Unfortunately it didn't help oral production very much. Many translators could translate easily from one language to another but could not actually speak the language. Just before the turn of the 20th century Charles Berlitz noticed that his students were speaking freely in conversation and seemed to be quite happy trying to converse without the use of grammar books and rules. With the advent of the second world war the scientific community battled between Noam Chomsky's “black box” theory which was non cognitive and Skinner's behavioural theories involving cognition. Since the Second World War there have been many theories put forth regarding oral production. Steven Krashen in the 70s and 80s put forth a number of theories regarding how children learn first language and that the closer that the conditions are to the situation in first language, the better the student learns language. Thomas Cook, working put forth a theory of shame in the 90s which is directly related to language learning.

### BACKGROUND AND SUMMARY OF THE INVENTION

A large percentage of people in the world study language. The goal of this effort is for people to communicate orally, having everyday conversations with reasonably little effort as in first language. 15% of the world's population are able to communicate efficiently in the workplace in two languages. For most people, efforts to speak in second language result in an abandoning of a language program. Human beings for the most part simply fail in their efforts to communicate orally in second language. Where necessity is the mother of invention, human beings have failed to fix the problem. There are reasons for this failure.

Human beings (human beings will be referred to as people or person) use the action of speaking in the majority of cases in order to communicate. For the average person, oral production appears to be the easiest way to communicate ideas in their mother tongue. That does not mean that speaking is easy. Speaking is the most difficult action that a person performs every day. The co-ordination problems of the brain, mouth, throat, vocal cords, lungs, and diaphragm in order to produce oral communication are not fully understood by experts. With those problems arrive a number of communication errors of greater and lesser value. Some mistakes are quickly forgotten and are easily fixed. Other mistakes have long-term consequences which have a greater negative value. Most people would deny the existence of these communication errors in reciting that oral communication is relatively easy and efficient. People are in denial regarding oral efficiency and have a tendency to quickly forget, repress or simply not think about oral production performance. A large part of communication in second language is done by E-mail and not orally. This is because people cannot communicate efficiently using oral production in second language and are afraid to speak. They are in denial regarding their capabilities in second language or know their capability in said language will result in some form of miscommunication. This must be explained to students in order to start the transition phase to a very small child. The explanation lowers expectation.

People in the 20th century have been conditioned to believe that their oral production in first language is extremely efficient. In the age of communication where televisions, radios, and spokespersons, the perception of oral production and its ease or difficulty has been greatly influenced. People believe that communication in big-screen movies, on television sitcoms, on radio programs and in press conferences is how a normal speech pattern of an individual should sound. People constantly imitate these communication idols with the hopes that their manner of oral production will improve. People believe that personalities associated with the industries such as television, radio, and media coverage have a special gift of intelligence. This is simply not true. People that work in the media have enormous resources that help them to sound close to perfect. They are able to rehearse presentations, re-shoot movie scenes, edit and eliminate any errors, and are constantly coached and educated regarding how to orally present ideas with the perception of perfection. Hollywood has actors and actresses suddenly communicating perfectly in languages other than English in scenes from different movies. This facade is far from reality but people have been conditioned to think that it is reality. With this kind of conditioning, the expectations of the average person regarding oral production are unrealistic and unattainable. This explanation is not obvious to most students and lowers expectation to facilitate the transition to a very small child.

Second language students discover quickly that failure when speaking is something that they do not fully understand. The oral production system comes with many factors that impede efficient communication. These physical impediments must be removed if the student is to continue the second language program. People understand immediately that there is a difference between their perception of oral production and the reality or production when they begin to try to communicate in second language. Physical signs of paralysis appear immediately and speech production becomes painstakingly slow and arduous. Speech ranges from zero to very little production. Physical speech impediments like babbling, stuttering, hesitating, breathing problems, dizziness, an inability to connect mentally with all information previously learned in second language, and paralysis of speech areas quickly appear in force. Students can experience nausea, headache, and stomach ache before the commencement of courses. Students have been known to unconsciously drive by the school without realizing that they have missed the turn. When speech impediments appear, it is difficult for students to rationalize this type of experience. The person may think about vocalizing words in a particular order but the resulting vocalized message is in a different order and the words may have changed. The entire exercise results in some form of failure to communicate the intended idea. It is not logical in the mind of the student that people can learn words, phrases, and grammar in second language and yet they are not able to produce an oral message using these grammar and vocabulary tools to communicate an idea. People take speaking for granted in their first language or mother tongue. While failure is something that people generally accept as a part of life, the student needs to understand why the failure occurred. People fail and learn from their failures, which is logical. When a person commits a failure when trying to communicate orally, this produces a failure which is in a category entirely different from all other failures and produces magnified physical symptoms that further prevent a person from efficiently communicating an oral message. This type of failure and its magnitude are only understood by people that have been placed in situations where they must orally communicate a message in second language.

The problem most relevant for second language speakers is the need to avoid the physically paralyzing symptoms that prevent them from speaking. In second language classrooms today, people learn through reasoning, cause-and-effect, and logical thinking as to how to improve their abilities and to reduce errors. This technique does nothing to address oral production improvement. Speaking is not a cognitive situation. If it was a cognitive situation, then most people in the world would be able to orally communicate efficiently in many languages. Efficient communication means that the person can communicate orally with ease and very few mistakes. This is not the case in the world today. Many people claim to have a great understanding of many languages, but in reality cannot produce efficient oral communication in these languages. Many people in the world translate from one language to another with ease but are unable but are unable to speak one of the languages fluently. People studying a particular language can graduate from respected universities around the world without actually being able to speak that language. What can be concluded is that speaking is not related to cognition. Speaking is something that people do not learn. People learn words, phrases, grammar but do not actually learn to speak. Again, speaking is not related to cognition. The process of the evolution of a person speaking a second language is not fully understood by experts. In the education systems of the world today related to second-language instruction, educators treat speaking as something that we learn to do. Students have the expectation that people learn to speak a second language. As in all other cognitive tasks, the task is generally achieved after learning. People learn words, phrases, and grammar but are unable to speak coherently in an efficient manner using the tools learned. As a result, the problem of the students needing to avoid the physically paralyzing impediments that prevent efficient oral production is still present. The situation has not been resolved because educators are not addressing the physically paralyzing impediments. Educators are forcing students to speak using cognitive techniques that are used for all other subjects in school. Speaking is not like all other subjects in school and must be addressed in an entirely different manner. Students that have experienced an atmosphere where cognitive techniques are not used, fully and completely understand this idea because the physically paralyzing symptoms that prevented them from speaking are no longer present. Education systems expect students to read words and grammar and vocalize them immediately. This situation adds more physical barriers because the student cannot rationalize why there is no oral output. This explanation is easily understood by students, targeting the problem in the mind of the students and preparing them for the transition solution.

Language is expressed orally and is a direct expression of the personality of the speaker. People are represented by what they say and how they say it. Individuals use language to differentiate themselves from other people regarding ideas, lifestyles, and points of view linked to their behaviour. Irving Goffman developed a theory that recites that people use language to create what he called “face”. This “face” is how people would like themselves to be represented to other people, and creates a social armour that protects them and makes them feel safe and secure. “Face” is a defence mechanism used to defend the self-esteem and confidence of a person in order to maintain a well-balanced personality. Any speech failures that are produced are a major threat to what Irving Goffman called “face”. This major threat leads to physical impediments that prevent oral production from occurring efficiently. These physical impediments are generally not felt or understood by people unless they are placed in a situation where they have to communicate a message orally and have difficulty doing so. This has generally been the problem with language research. Language researchers simply do not speak second languages and rarely experience these physical symptoms. These physical barriers can appear in first language situations when people are under duress or in an emotionally charged state. People that are placed in positions where they must communicate in second language such a second language students, foreign businessmen, tourists, and diplomats fully understand these physical impediments and the necessity to avoid them at all costs.

It is important to examine a second language situation where a student is placed in a cognitive learning environment where the student tries to produce an oral message. Thomas Cook researched this question with a study of Spanish speakers learning English in the United States. The students were not able to produce the desired oral communication results in class. This produced shame which is a direct result of a threat to a person's “face”. The result of this shame was that students became angry at themselves, at other students, and at the teacher. The result of this anger was that most students abandoned their second language program. According to Cook, only a few students persevered and continued to evolve as second language speakers. This percentage was very small and leads to the conclusion that a cognitive environment simply does not produce a successful result. The paralyzing physical impediments produced when a student fails to produce oral production produce counterproductive emotions leading to an abandonment of the program. This stage in the evolution of the second language student (where the result in a cognitive environment is failure) must be resolved. This is why such a small percentage of the world can efficiently speak in more than one language. If the physically paralyzing symptoms that threaten the “face” (or self-esteem) of the individual can be eliminated, this stage of abandonment in second language will be substantially reduced and the successful result of students speaking a second language will be achieved.

Shame is caused by inflicting injury on a person's “face” or self-esteem. This is easily done in a cognitive language learning environment. People are not judged by what they think but by how oral production is produced. People may be thinking about a particular oral message but another message is produced orally. Oral production that is completely logical for one person may be completely illogical to another and deserving of criticism. People stammer, stutter, correct themselves, and even tell their audience to forget what was just vocalized. Oral production is personal and linked to a person's personality. There may be any number of reasons to criticize what people say and how the message was produced but whatever the reasons, they are a major threat to our “face” and cause shame. There are many ways to express ideas and people do not always agree on how these ideas are expressed. It is plainly evident that in our society many people have been criticized for what they said and have learned to avoid speaking. This is because shame intervenes, adding paralysis to the already paralyzed speech process, leaving people with the inability to defend their self esteem. The result is that people stop voicing their opinions and ideas. This is the damage caused in a cognitive environment in first language where people take the action of speaking for granted. It is easy to imagine the position of a person in a cognitive second language environment where the person lacks many of the tools such as vocabulary and correct pronunciation necessary to produce oral production efficiently. The physically paralyzing effects of confrontation in second language produce shame, which in turn creates more paralyzing symptoms, producing a rollover effect.

People have avoided these paralyzing physical impediments and produced oral messages in second language without the accompanying negative side effects like shame. This has been accomplished after drinking alcoholic beverages and while producing many errors and miscommunication, does not lead to the abandoning of a language program. For reasons that are obvious, this is not a viable solution to the problem of eliminating speech impediments. This situation demonstrates however that the paralyzing physical impediments can be eliminated. It cannot be denied that the real problem of oral production are the physical impediments. The education system needs a more practical solution.

Students at this point are reliving all of their previous speaking experiences which have for most students ranged from difficult to situations of fear and anger.

D-BLOK eliminates physically paralyzing impediments that accompany oral production of a second language speaker. The student is told that he is a baby with no cognition and therefore is not able to control oral production. When students understand that oral production and intelligence are not linked, students realize they are not responsible for any oral production produced. Students understand that they cannot control oral production without making many errors in the early stages of speaking. When students understand that they are not at fault regarding any mistakes made in oral production, physically paralyzing symptoms of oral production gradually disappear. With this gradual disappearance of physically paralyzing symptoms, the student may still do the following: babble, stutter, recite words that are out of order, mispronounce words and generally experiment with sound and accent. These actions will not produce shame and more physical impediments because students know that speaking is not cognitive and that they cannot be held responsible for these failures. This experimentation is vital to oral production success. Without this type of experimentation, it would be impossible for the student to evolve positively regarding oral production. The complicated coordination of the mechanics of sound production coupled with breathing, thinking, unblocking of speech pathways, and muscle coordination take time to facilitate. If the second language student is not able to experiment freely in this manner for long periods of time without the shame and that cause physical speech paralysis, the student will abandon the program. Taking the student back to the situation of being a very small child has nothing to do with learning or cognitive reasoning. This explanation is made in order to facilitate the understanding that cognition and oral production are not related. This allows the student to babble freely without negative consequences, leading to a disappearance of speech paralysis which in turn keeps the student coming back to the classroom. Any threats to the self esteem from a return to a cognitive speaking environment of the individual will result in a decrease in oral production leading to the abandoning of the language program.

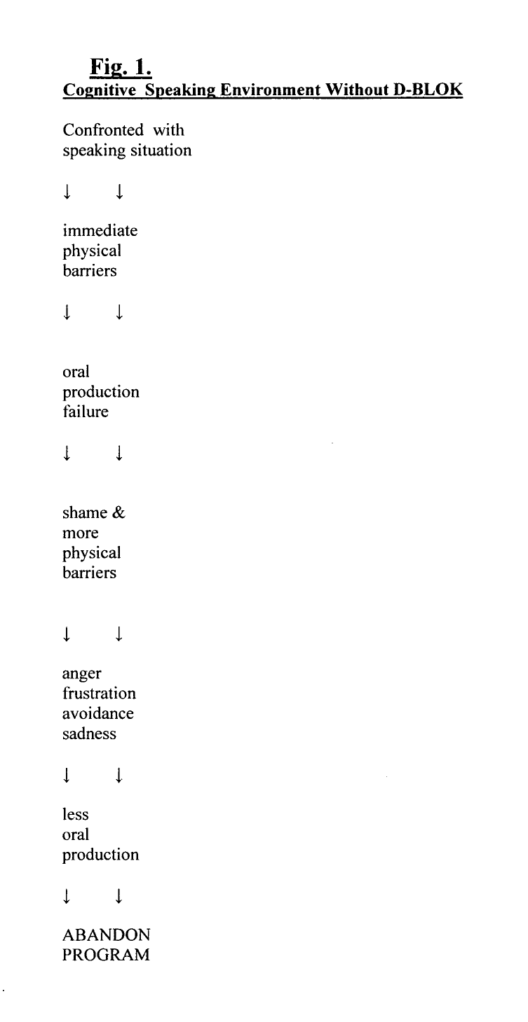

FIG. 1. Depicts the sequence of events and reactions of students in a learning environment where the presence of barriers is not prevented, leading to the final step which is abandonment.

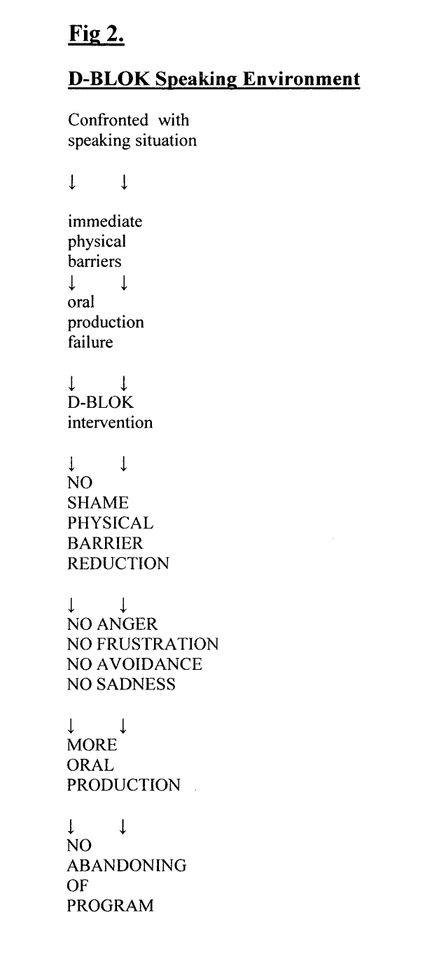

FIG. 2. Depicts the sequence of events under the D-Blok method, when to implement the method and the positive outcome for the student.

D-BLOK reduces the expectation of the student and the teacher to zero. The result of this action is to reduce speech impediments and at the same time prevent more impediments from appearing. A very small child is not expected to produce complicated messages but is expected to produce messages that are not always clear. Students grow up in an education system where learning is based on logical reasoning. It is logical that when students learn words and phrases, they are expected to use those words and phrases in oral production. The education system cannot accurately evaluate oral production at this point in time because experts do not fully understand it. As a result, students are unfairly awarded evaluations that make them appear to lack intelligence when in reality they cannot control oral production like other cognitive activities. This creates panic, shame and more paralyzing effects on speech production that need to be avoided. Teachers should have a zero expectation of the student in an oral production situation. If the teacher shows any kind of expectation, this would be a direct threat to the self esteem of the student. This action will increase speech impediments as well as reducing the oral output of the student. A student watches media production every day on television and the Internet, listens to the radio, as well as watching politicians and spokespersons live at press conferences. The expectations that are created regarding language production are very high in first and second language. Explanations must be given to students regarding how the media industry presents vocalized speech and how it differs from everyday speech conversation. This will lower the speech expectations of the student to a realistic level. It must be explained that success in oral production occurs each time that a student produces an oral message. The message created may or may not be intelligible, but this is success in the eyes of the teacher. Very small children have little or no control over oral production but continue to produce it with no paralyzing speech problems. There is no shame which produces speech impediments because the child and the audience have no expectation and never show disappointment. This explanation that students are very small children facilitates the understanding that expectations are zero. The explanation is not in any way liked with the cognitive learning ability of a child.

Second language students need to understand that speaking has nothing to do with cognitive learning. From a very early age people are educated in cognitive environments. For most people, speaking is thought of as a cognitive action like all other learned tasks in life. If people do not achieve the desired results, this failure is a direct threat to the “face” or self-esteem of students. Students are placed in second language speaking situations where failure is inevitable, resulting in a direct threat to their self-esteem. When students practise orally and do not achieve the desired results, the loss of self-esteem drives the students to abandon the program. (Only a small percentage of students continue to achieve the desired results.) In order to prevent abandoning the second language program, students must be provided with a defence that will not only reduce physical impediments but will also prevent more additional physical impediments. When students are provided with the explanation that oral production is not cognitive, this frees them from obtaining any results that would be expected in a cognitive situation. This explanation protects the “face” of the student. The explanation allows the student to defend himself against any criticism regarding produced oral production, eliminating negative emotions that cause students to abandon programs. This explanation is essential because students need a rational explanation as to why they are failing what they consider to be a simple task. A very small baby does not need this kind of explanation. When the student is told that he is a very small child, this helps to facilitate his understanding that speaking is not a cognitive action as very small children have very little cognition. Second language students immediately understand this message after experiencing speaking situations early in the second language program. Without this explanation students are likely to abandon the program due to negative emotions produced by physical speaking impediments. People who have experienced second language speaking situations have no difficulty understanding the explanation that speaking is not a cognitive action. This explanation is more difficult to understand for people that have never experienced an oral confrontation in second language.

Students at this point have been given a logical option to avoid the negative experiences in their past. Because students are willing to avoid the shame that causes emotions like anger, frustration, and sadness, the students will happily make this transition which produces more oral output and keeps them in the classroom. Students will immediately produce more oral output and improve with this kind of experimentation. The physical barriers and negative emotions disappear as the student gains confidence with more experimentation. Without this opportunity, the student will experience more physical symptoms which will lead to the abandoning of the program. The reinforcement must continue as students easily forget their past experiences and must be constantly reminded so that the students take more risk as their capabilities improve.

This abandoning of the program is the major problem in education systems today, wasting incalculable resources and time. Abandoning of language programs is most evident in the early stages of the program. Abandoning a language program can happen at any time even when students has mastered many verb tenses. Because students are always in cognitive environments, D-BLOK technique must be constantly re-enforced to prevent the reappearance of physical impediments. Many people who can communicate reasonably well in a second language abandon the program because they feel that the threat to their “face” or self-esteem outweighs the advantages of improving their oral situation. This can be prevented with constant D-BLOK application. The small percentage of people that can work in two languages indicates that people do not learn to speak a language in a cognitive environment. Second language programs are not producing second language speakers because the physical barriers prevent efficient oral production. The physical barriers that prevent students from speaking must be eliminated in order for the students to continue the program and efficiently produce oral messages.

A student needs a reasonable explanation as to why he is not easily performing what he considers to be an easy task. A student feels that if he does not produce good oral output, then he lacks some form of intelligence. Once the student has an explanation about the background of oral production and all the related ides that he takes for granted, the student will easily transition to the very small child in order to facilitate oral production and to escape the physical factors and accompanying negative emotions. The student wants to succeed and enjoy the experience, the opposite of what he has experienced in the past.

D-BLOK method eliminates physical barriers that prevent speech production in situations where oral responses are needed to communicate. These physical barriers include paralysis of speech areas of the human body, extreme muscle tension, irregular breathing, dizziness and numbness. These physical barriers can produce a lack of muscle co-ordination resulting in undesirable speech delivery output such as stuttering, stammering pronunciation problems, and garbled speech.

D-BLOK method prevents the physical barriers that impede oral production from re-appearing as the oral production of the second language student evolves.

D-BLOK method eliminates the abandoning of second language programs as a result of physical impediments experienced in second language oral response situations by students.

1. A method for second language oral expression teaching called D-Block, where the teacher eliminates physical barriers, which can produce a lack of muscle co-ordination preventing speech production in situations where oral responses are needed to communicate, by transitioning the student back to the age of approximately one to two years old.

2. A method as described in 1, where the transition of the student occurs by inducing a positive effect on the brain of the subject as a result of the verbal repetitive stimuli offered by the teacher indicating to the subject that he is a baby or a small child.

3. A method as described in 1, where the student is offered a credible explanation that he cannot control his speech output in the early stages of oral development in second language, just like a very small child. The student is reminded that his speaking behaviour closely resembles the behaviour of a very small child, without cognition or the power to reason. The idea that speaking and intelligence are not related re-enforces the transition back to the age of a very small child.

4. A method as described in 1, where the student is offered the explanation that cognition actually prevents oral production, which is why a very small child with very limited cognitive powers is able to produce oral production freely at will. This re-enforces the transition back to the age of 1 or 2 years old.

5. A method described in 1, where the transition back to the age of 1 or 2 years old is re-enforced by explanations that the student is not responsible for oral production errors, just like the very small child does not suffer consequences for his oral production because he is not responsible in the eyes of the parents. This re-enforces the transition back to the age of 1 or 2 years old because it relieves the student of the responsibility for the consequences of failure. Students are desperate to avoid these consequences that produce and increase physical oral barriers and thus happily accept the environment of a small child with no consequences.

6. A method described in 1, where the student is offered the explanation that any oral production results of the student resemble the behaviour of a very small child who's oral production errors do not threaten the self esteem of the child. This reinforces the transition back to the age of 1 or 2 years old and prevents physical barriers from reappearing.

7. A method described in 1, where the student is reminded that he is a small child, who does not speak like people in the media, in movies, and on radio. This re-enforces the transition back to the age of 1 or 2 by lowering the expectations of the student to the level of a very small child. This removal of expectation removes physical barriers and prevents them from reappearing, because the student is free to experiment with language in oral production without the expectation of success. Expectation adds physical barriers which students will gladly escape with the transition to the environment of a small child.

8. A method described in 1, where the expectation of the teacher is lowered to 0, just like the expectation with a very small child. This helps re-enforce the transition because the student is being treated like a very child without any intelligence markers such as cause and effect, reasoning, and critical thinking. The student does not suffer the consequences of a cognitive environment and like a very small child, increases his oral production.

9. A method described in 1, where all of the above information must be continually explained to the student because there has never been a credible explanation as to why the student is failing what he believes to be an action related to intelligence. The transition occurs because the explanations target the cause of the physical barriers and gives the student an easy option of the atmosphere of a 1 or 2 year old child in order to avoid the shame and other negative emotions that produce more physical barriers. The transition becomes more permanent with time as oral production increases.
